(19) United States
(12) Patent Application Publication
(10) Pub. No.: US 2011/0292172 A1
(43) Pub. Date: Dec. 1, 2011

(54) VIDEO SIGNAL PROCESSING APPARATUS, VIDEO SIGNAL PROCESSING METHOD, AND COMPUTER PROGRAM

(75) Inventor: Shigeru Harada, Tokyo (JP)

(73) Assignee: SONY CORPORATION, Tokyo (JP)

(21) Appl. No.: 13/111,158

(22) Filed: May 19, 2011

(30) Foreign Application Priority Data
May 28, 2010 (JP) P2010-122336

(51) Int. Cl. H04N 13/00

(52) U.S. Cl. 348/43; 348/E13.064

(57) ABSTRACT

A video signal processing apparatus includes a histogram detecting unit detecting a histogram of a luminance distribution of either one of a left-eye video signal and a right-eye video signal among input stereoscopic video signals, a gamma-curve calculating unit calculating a gamma curve based on the histogram detected by the histogram detecting unit, and a gamma-curve output unit correcting the left-eye video signal and the right-eye video signal based on the gamma curve calculated by the gamma-curve calculating unit.

### CROSS-REFERENCE TO RELATED APPLICATION

The present application claims priority from Japanese Patent Application No. JP 2010-122336 filed in the Japanese Patent Office on May 28, 2010, the entire content of which is incorporated herein by reference.

### BACKGROUND

The present disclosure relates to a video signal processing apparatus, video signal processing method, and computer program for processing a stereoscopic video formed of a left-eye video signal and a right-eye video signal and, in particular, to a video signal processing apparatus, video signal processing method, and computer program for correcting image quality of a stereoscopic video.

By displaying videos with a parallax for the left and right eyes, it is possible to present a stereoscopic video that appears three-dimensionally to an observer. In one technique of presenting a stereoscopic video, eyeglasses with a special optical characteristic are mounted on the observer, and images with a parallax between the left and right eyes are presented. For example, a time-division stereoscopic video display system includes a combination of a display apparatus displaying a plurality of different videos in a time-division manner and shutter eyeglasses to be mounted on a video observer. The display apparatus displays a left-eye video and a right-eye video on a screen in an extremely short cycle and, at the same time, provides a video as being separated for the left eye and the right eye in synchronization with the cycle of the left-eye video and the cycle of the right-eye video. On the other hand, in the shutter eyeglasses mounted on the observer, while the left-eye video is being displayed, a left-eye part of the shutter eyeglasses lets light pass, and a right-eye part thereof shields light. Also, while the right-eye video is being displayed, the right-eye part of the shutter eyeglasses lets light pass, and the left-eye part shields light.

Television sets, VTRs (video tape recorders), digital cameras, television cameras, printers, or the like have an image processing function of outputting an input image with its image quality being corrected (for example, functions of adjusting light and darkness and contrast and performing edge correction). This image processing function is effectively applied mainly to an image that is dark as a whole with a low contrast and an image with blurred details.

Also, in the stereoscopic video display system described above, since a left-eye video and a right-eye video are shot normally by two cameras, the luminance and distortion of the lenses, a difference in light amount due to the positions of the cameras, and others are corrected so that the same video is displayed on left and right. Furthermore, image quality is corrected regarding each of the left and right videos.

Of image quality correction, contrast adjustment is performed by normally correcting a gamma curve representing a so-called gamma characteristic. For example, a method of using a histogram distribution representing a luminance distribution of an input image includes three processes: detection of a histogram of a luminance distribution of an input image, calculation of a gamma curve based on the histogram, and correction of the input image using the gamma curve.

When the image processing function is applied to the stereoscopic video described above, if image quality correction is performed on two left-eye and right-eye video signals as they are, the amount of process is enormous. Also, if the process result for each of the left-eye and right-eye video signals differs, this may disadvantageously cause flicker. Moreover, to separately detect the performances of the left-eye and right-eye video signals, the detection is made quickly, because a long detection time may disadvantageously make it difficult to apply the image processing function to live broadcasting of moving images.

For example, a stereoscopic video signal processing apparatus has been suggested in which a histogram of each of left and right videos is detected and one video signal is corrected so as to reduce a difference therebetween (for example, refer to Japanese Unexamined Patent Application Publication No. 2007-151125). In this processing apparatus, however, since gamma control is performed on both of the left and right video signals (note that one is corrected), the amount of process is enormous.

### SUMMARY

It is desirable to provide an excellent video signal processing apparatus, video signal processing method, and computer program capable of quickly correcting image quality of a stereoscopic video with a small amount of process.

It is further desirable to provide an excellent video signal processing apparatus, video signal processing method, and computer program capable of quickly performing a contrast process on each of a left-eye video signal and a right-eye video signal with a small amount of process.

According to a first embodiment of the present disclosure, a video signal processing apparatus includes a histogram detecting unit detecting a histogram of a luminance distribution of either one of a left-eye video signal and a right-eye video signal among input stereoscopic video signals, a gamma-curve calculating unit calculating a gamma curve based on the histogram detected by the histogram detecting unit, and a gamma-curve output unit correcting the left-eye video signal and the right-eye video signal based on the gamma curve calculated by the gamma-curve calculating unit.

According to a second embodiment of the present disclosure, a video signal processing apparatus includes a left-eye video signal histogram detecting unit detecting a histogram of a luminance distribution of a left-eye video signal among input stereoscopic video signals, a right-eye video signal histogram detecting unit detecting a histogram of a luminance distribution of a right-eye video signal among the stereoscopic video signals, a minimizing unit minimizing the histograms detected by the left-eye video signal histogram detecting unit and the right-eye video signal histogram detecting unit for each luminance level, a gamma-curve calculating unit calculating a gamma curve based on the histograms processed by the minimizing unit, and a gamma-curve output unit correcting the left-eye video signal and the right-eye video signal based on the gamma curve calculated by the gamma-curve calculating unit.

According to a third embodiment of the present disclosure, a video signal processing apparatus includes a left-eye video signal histogram detecting unit detecting a histogram of a luminance distribution of a left-eye video signal among input stereoscopic video signals, a right-eye video signal histogram detecting unit detecting a histogram of a luminance distribution of a right-eye video signal among the stereoscopic video signals, an averaging unit weighted-averaging the histograms detected by the left-eye video signal histogram detecting unit and the right-eye video signal histogram detecting unit, a gamma-curve calculating unit calculating a gamma curve based on the histograms weighted-averaged by the averaging unit, and a gamma-curve output unit correcting the left-eye video signal and the right-eye video signal based on the gamma curve calculated by the gamma-curve calculating unit.

According to a fourth embodiment of the present disclosure, a video signal processing apparatus includes a left-eye video signal histogram detecting unit detecting a histogram of a luminance distribution of a left-eye video signal among input stereoscopic video signals, a right-eye video signal histogram detecting unit detecting a histogram of a luminance distribution of a right-eye video signal among the stereoscopic video signals, a minimizing unit minimizing the histograms detected by the left-eye video signal histogram detecting unit and the right-eye video signal histogram detecting unit for each luminance level, an averaging unit weighted-averaging the histograms detected by the left-eye video signal histogram detecting unit and the right-eye video signal histogram detecting unit, a selecting unit selecting any one of the histograms output from the left-eye video signal histogram detecting unit, the minimizing unit, and the averaging unit, a gamma-curve calculating unit calculating a gamma curve based on the histogram selected by the selecting unit, and a gamma-curve output unit correcting the left-eye video signal and the right-eye video signal based on the gamma curve calculated by the gamma-curve calculating unit.

According to a fifth embodiment of the present disclosure, a video signal processing method includes a histogram detecting step of detecting a histogram of a luminance distribution of either one of a left-eye video signal and a right-eye video signal among input stereoscopic video signals, a gamma-curve calculating step of calculating a gamma curve based on the histogram detected in the histogram detecting step, and a gamma-curve outputting step of correcting the left-eye video signal and the right-eye video signal based on the gamma curve calculated in the gamma-curve calculating step.

According to a sixth embodiment of the present disclosure, a video signal processing method includes a left-eye video signal histogram detecting step of detecting a histogram of a luminance distribution of a left-eye video signal among input stereoscopic video signals, a right-eye video signal histogram detecting step of detecting a histogram of a luminance distribution of a right-eye video signal among the stereoscopic video signals, a minimizing step of minimizing the histograms detected in the left-eye video signal histogram detecting step and the right-eye video signal histogram detecting step for each luminance level, a gamma-curve calculating step of calculating a gamma curve based on the histograms processed in the minimizing step, and a gamma-curve outputting step of correcting the left-eye video signal and the right-eye video signal based on the gamma curve calculated in the gamma-curve calculating step.

According to a seventh embodiment of the present disclosure, a video signal processing method includes a left-eye video signal histogram detecting step of detecting a histogram of a luminance distribution of a left-eye video signal among input stereoscopic video signals, a right-eye video signal histogram detecting step of detecting a histogram of a luminance distribution of a right-eye video signal among the stereoscopic video signals, an averaging step of weighted-averaging the histograms detected in the left-eye video signal histogram detecting step and the right-eye video signal histogram detecting step, a gamma-curve calculating step of calculating a gamma curve based on the histograms weighted-averaged in the averaging step, and a gamma-curve outputting step of correcting the left-eye video signal and the right-eye video signal based on the gamma curve calculated in the gamma-curve calculating step.

According to an eighth embodiment of the present disclosure, a video signal processing method includes a left-eye video signal histogram detecting step of detecting a histogram of a luminance distribution of a left-eye video signal among input stereoscopic video signals, a right-eye video signal histogram detecting step of detecting a histogram of a luminance distribution of a right-eye video signal among the stereoscopic video signals, a minimizing step of minimizing the histograms detected in the left-eye video signal histogram detecting step and the right-eye video signal histogram detecting step for each luminance level, an averaging step of weighted-averaging the histograms detected in the left-eye video signal histogram detecting step and the right-eye video signal histogram detecting step, a selecting step of selecting any one of the histograms output in the left-eye video signal histogram detecting step, the minimizing step, and the averaging step, a gamma-curve calculating step of calculating a gamma curve based on the histogram selected in the selecting step, and a gamma-curve outputting step of correcting the left-eye video signal and the right-eye video signal based on the gamma curve calculated in the gamma-curve calculating step.

According to a ninth embodiment of the present disclosure, a computer program described in a computer-readable format so that stereoscopic video signals are processed on a computer causes the computer to function as units including a histogram detecting unit detecting a histogram of a luminance distribution of either one of a left-eye video signal and a right-eye video signal among the stereoscopic video signals, a gamma-curve calculating unit calculating a gamma curve based on the histogram detected by the histogram detecting unit, and a gamma-curve output unit correcting the left-eye video signal and the right-eye video signal based on the gamma curve calculated by the gamma-curve calculating unit.

According to a tenth embodiment of the present disclosure, a computer program described in a computer-readable format so that stereoscopic video signals are processed on a computer causes the computer to function as units including a left-eye video signal histogram detecting unit detecting a histogram of a luminance distribution of a left-eye video signal among the stereoscopic video signals, a right-eye video signal histogram detecting unit detecting a histogram of a luminance distribution of a right-eye video signal among the stereoscopic video signals, a minimizing unit minimizing the histograms detected by the left-eye video signal histogram detecting unit and the right-eye video signal histogram detecting unit for each luminance level, a gamma-curve calculating unit calculating a gamma curve based on the histograms processed by the minimizing unit, and a gamma-curve output unit correcting the left-eye video signal and the right-eye video signal based on the gamma curve calculated by the gamma-curve calculating unit.

According to an eleventh embodiment of the present disclosure, a computer program described in a computer-readable format so that stereoscopic video signals are processed on a computer causes the computer to function as units including a left-eye video signal histogram detecting unit detecting a histogram of a luminance distribution of a left-eye video signal among the stereoscopic video signals, a right-eye video signal histogram detecting unit detecting a histogram of a luminance distribution of a right-eye video signal among the stereoscopic video signals, an averaging unit weighted-averaging the histograms detected by the left-eye video signal histogram detecting unit and the right-eye video signal histogram detecting unit, a gamma-curve calculating unit calculating a gamma curve based on the histograms weighted-averaged by the averaging unit, and a gamma-curve output unit correcting the left-eye video signal and the right-eye video signal based on the gamma curve calculated by the gamma-curve calculating unit.

According to a twelfth embodiment of the present disclosure, a computer program described in a computer-readable format so that stereoscopic video signals are processed on a computer causes the computer to function as units including a left-eye video signal histogram detecting unit detecting a histogram of a luminance distribution of a left-eye video signal among the stereoscopic video signals, a right-eye video signal histogram detecting unit detecting a histogram of a luminance distribution of a right-eye video signal among the stereoscopic video signals, a minimizing unit minimizing the histograms detected by the left-eye video signal histogram detecting unit and the right-eye video signal histogram detecting unit for each luminance level, an averaging unit weighted-averaging the histograms detected by the left-eye video signal histogram detecting unit and the right-eye video signal histogram detecting unit, a selecting unit selecting any one of the histograms output from the left-eye video signal histogram detecting unit, the minimizing unit, and the averaging unit, a gamma-curve calculating unit calculating a gamma curve based on the histogram selected by the selecting unit, and a gamma-curve output unit correcting the left-eye video signal and the right-eye video signal based on the gamma curve calculated by the gamma-curve calculating unit.

The computer programs according to the ninth to twelfth embodiments of the present disclosure are defined as being described in a computer-readable format for performing a predetermined process on a computer. In other words, with the computer program according to any of the ninth to twelfth embodiments of the present disclosure being installed on a computer, a cooperative operation is provided on the computer, and operations and effects of the video signal processing apparatuses according to the first to fourth embodiments of the present disclosure can be obtained.

According to the embodiments of the present disclosure, it is possible to provide an excellent video signal processing apparatus, video signal processing method, and computer program capable of quickly performing a contrast process on each of a left-eye video signal and a right-eye video signal with a small amount of process.

According to the first, fifth, and ninth embodiments of the present disclosure, calculation of a gamma curve for contrast correction on two left and right videos is performed only once, thereby reducing an amount of process. Also, only by cutting a histogram detection period by half, contrast correction on both of the left-eye video signal and the right-eye video signal can be made with the same process for a two-dimensional video signal. Furthermore, since a difference in performance between a left-eye video and a right-eye video is subtle, a detrimental influence of cutting the histogram detection period by half is small.

According to the second, sixth, and tenth embodiments of the present disclosure, by minimizing the histograms of the luminance distribution of the left and right video signals, a gamma curve can be calculated by ignoring a luminance distribution of an occlusion region and only using histogram information common to both of the left and right eyes.

According to the third, seventh, and eleventh embodiments of the present disclosure, even when a difference in performance between the left-eye video signal and the right-eye video signal is large, the histograms of the luminance distributions detected from the left-eye video signal and the right-eye video signal are weighted-averaged, thereby reducing an influence of the difference in performance.

According to the fourth, eighth, and twelfth embodiments of the present disclosure, for example, an output from the left-eye video signal histogram detecting unit can be selected when the histogram detection period is desired to be shortened, an output from the minimizing unit can be selected when an influence of the occlusion region is desired to be eliminated, and an output from the averaging unit can be selected when a difference in performance between the left and right video signal is desired to be reduced.

Further features and advantages of embodiments of the present disclosure will become apparent from more detailed description based on embodiments of the present disclosure described below and the attached drawings.

### BRIEF DESCRIPTION OF THE DRAWINGS

FIG. 1 is a schematic drawing of the structure of a stereoscopic video display system to which an embodiment of the present disclosure is applicable;

FIG. 2 is a drawing that depicts an operation of controlling shutter eyeglasses in an L sub-frame period;

FIG. 3 is a drawing that depicts an operation of controlling the shutter eyeglasses in an R sub-frame period;

FIG. 4A is a drawing for describing an algorithm for contrast correction;

FIG. 4B is a drawing for describing an algorithm for contrast correction;

FIG. 5A is a drawing for describing an algorithm for contrast correction;

FIG. 5B is a drawing for describing an algorithm for contrast correction;

FIG. 6A is a drawing for describing an algorithm for contrast correction;

FIG. 6B is a drawing for describing an algorithm for contrast correction;

FIG. 7A is a drawing for describing an algorithm for contrast correction;

FIG. 7B is a drawing for describing an algorithm for contrast correction;

FIG. 8 is a block diagram of a functional structure for contrast correction according to an embodiment of the present disclosure;

FIG. 9 is a timing chart for contrast correction in functional blocks depicted in FIG. 8;

FIG. 10 is a block diagram of a functional structure for contrast correction according to another embodiment of the present disclosure;

FIG. 11 is a timing chart for contrast correction in functional blocks depicted in FIG. 10;

FIG. 12 is a block diagram of a functional structure for contrast correction according to still another embodiment of the present disclosure; and

FIG. 13 is a block diagram of a functional structure for contrast correction according to yet another embodiment of the present disclosure.

### DETAILED DESCRIPTION OF EMBODIMENTS

With reference to the drawings, embodiments of the present disclosure are described in detail below.

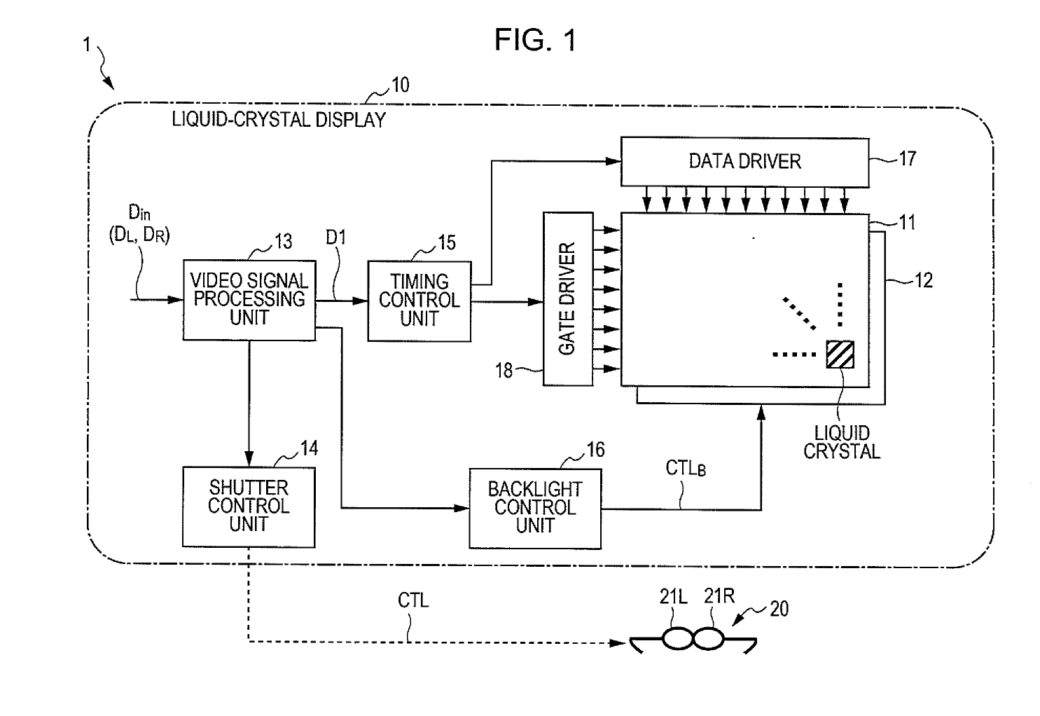

FIG. 1 schematically depicts the structure of a stereoscopic video display system 1 to which an embodiment of the present disclosure can be applied. The stereoscopic video display system 1 includes a liquid-crystal display 10 for alternate screen display of a left-eye video L and a right-eye video R in an extremely short cycle and shutter eyeglasses 20 to be mounted on the head of an observer.

The liquid-crystal display 10 includes a liquid-crystal display panel 11, a backlight 12, a video signal processing unit 13, a shutter control unit 14 controlling open/close timing of a shutter mechanism of the shutter eyeglasses 20, a timing control unit 15, a backlight control unit 16, and a data driver 17 and a gate driver 18. In the present embodiment, the liquid-crystal display 10 displays and outputs a video based on an input video signal Dᵢₙ including a right-eye video signal D_{R} and a left-eye video signal D_{L} having a parallax therebetween.

The liquid-crystal display panel 11 is, for example, of an active matrix type in which TFTs are arranged for each pixel. The backlight 12 is a light source emitting light to the liquid-crystal display panel 11. The backlight 12 is controlled so as to switch between a lighting (light-emitting) operation and a lighting-out operation in a time-division manner based on a control signal CTL_{B} supplied from the backlight control unit 16.

As the backlight 12, for example, an LED (light emitting diode) or a CCFL (cold cathode fluorescent lamp) can be used. However, when a CCFL is used, afterglow tends to occur, and also an afterglow characteristic differs for each color of RGB. Thus, in the following, it is assumed for convenience of description that an LED with less afterglow is used as the backlight 12.

The liquid-crystal display panel 11 has a plurality of pixels arranged in a matrix as a whole and, based on a video voltage supplied from the data driver 17, modulates light emitted from the backlight 12 according to a drive signal supplied from the gate driver 18, thereby displaying video based on the input video signal Dᵢₙ. In the present embodiment, the liquid-crystal display panel 11 alternately displays, in a time-division manner, a right-eye video R based on the right-eye video signal D_{R} and a left-eye video L based on a left-eye video signal D_{L} in a predetermined cycle, such as one frame period.

The video signal processing unit 13 controls the order of writing (that is, the order of displaying) the right-eye video signal D_{R} and the left-eye video signal D_{L} in the liquid-crystal display panel 11 based on the input video signal Dᵢₙ, thereby generating a video signal to the liquid-crystal display panel 11. In the present embodiment, from the input video signal Dᵢₙ, the video signal processing unit 13 generates, in one frame period, a video signal D1 in which the left-eye video signal D_{L} and the right-eye video signal D_{R} are alternately arranged. Note that, in the following, a period for displaying the left-eye video L is refereed to as an L sub-frame period and a period for displaying the right-eye video R is refereed to as an R sub-frame period in one frame period.

Also, for the left-eye video and the right-eye video, the video signal processing unit 13 corrects a difference in light amount due to the luminance or distortion of a lens or a camera position so that the same video is displayed on the left and right. Also, for each of the left-eye video and the right-eye video, the video signal processing unit 13 corrects image quality, such as adjusting light and darkness and contrast and performing edge correction.

The timing control unit 15 controls driving timing of the gate driver 18 and the data driver 17, and also supplies the video signal D1 supplied from the video signal processing unit 13 to the data driver 17. The timing control unit 15 may perform an overdrive process on the video signal D1.

The gate driver 18 sequentially drives the respective pixels in the liquid-crystal display panel 11 along a gate line according to timing control by the timing control unit 15.

The data driver 17 supplies, to each pixel of the liquid-crystal display panel 11, a video voltage based on the video signal D1 supplied from the timing control unit 15. Specifically, the data driver 17 performs D/A conversion on the video signal D1 to generate an analog video signal corresponding to the video voltage, and outputs the analog video signal to each pixel.

The shutter control unit 14 outputs to the shutter eyeglasses 20 a timing control signal CTL for controlling switching between opening and closing left and right shutter mechanism corresponding to an output timing of the video signal processing unit 13 for outputting each of the right-eye video signal D_{R} and the left-eye video signal D_{L}.

The shutter eyeglasses 20 is mounted on the observer (not particularly shown in FIG. 1) of the liquid-crystal display 10 for allowing stereoscopic viewing. The shutter eyeglasses 20 has a left-eye lens 21L and a right-eye lens 21R. The left-eye lens 21L and the right-eye lens 21R each have a light-shielding shutter (not shown) for shielding an opening from light disposed therein. The light-shielding shutter includes, for example, a liquid-crystal shutter. A valid state (that is, a closed state) and an invalid state (that is, an open state) of the light-shielding function in this light-shielding shutter are controlled with a control signal CTL supplied from the shutter control unit 14.

The shutter control unit 14 controls the light-shielding shutters of the shutter eyeglasses 20 so that the open state and the closed state are alternately switched in each of the left-eye lens 21L and the right-eye lens 21R correspondingly to each display period of the left-eye video L and the right-eye video R. Specifically, control is performed so that the light-shielding shutter of the left-eye lens 21L is set in an open state and the light-shielding shutter of the right-eye lens 21R is set in a closed state in the L sub-frame period and the light-shielding shutter of the right-eye lens 21R is set in an open state and the light-shielding shutter of the left-eye lens 21L is set in a closed state in the R sub-frame period.

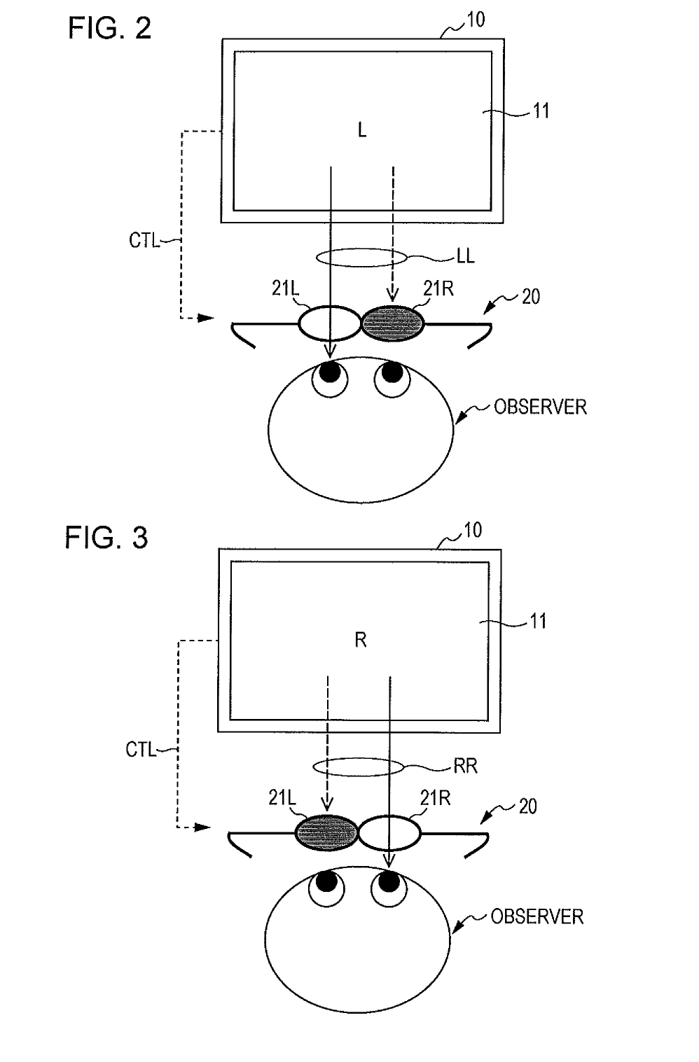

FIG. 2 depicts a control operation of the shutter eyeglasses 20 in the L sub-frame period. As depicted, in the L sub-frame period, with the control signal CTL from the shutter control unit 14, the shutter of the left-eye lens 21L is set in an open state, and the shutter of the right-eye lens 21R is set in a closed state, thereby letting display light LL based on the left-eye video L pass only through the left-eye lens 21L. FIG. 3 also depicts a control operation of the shutter eyeglasses 20 in the R sub-frame period. As depicted, in the R sub-frame period, with the control signal CTL from the shutter control unit 14, the shutter of the right-eye lens 21R is set in an open state, and the shutter of the left-eye lens 21L is set in a closed state, thereby letting display light RR based on the right-eye video R pass only through the right-eye lens 21R.

In the stereoscopic video display system 1 depicted in FIG. 1, as described above, for each of the left-eye video and the right-eye video, the video signal processing unit 13 corrects image quality, such as adjusting light and darkness and contrast and performing edge correction.

Of image quality correction, contrast adjustment is performed by normally correcting a gamma curve representing a so-called gamma characteristic. For example, a method of using a histogram distribution representing a luminance distribution of an input image includes three processes: detection of a histogram of a luminance distribution of an input image, calculation of a gamma curve based on the histogram, and correction of the input image using the gamma curve.

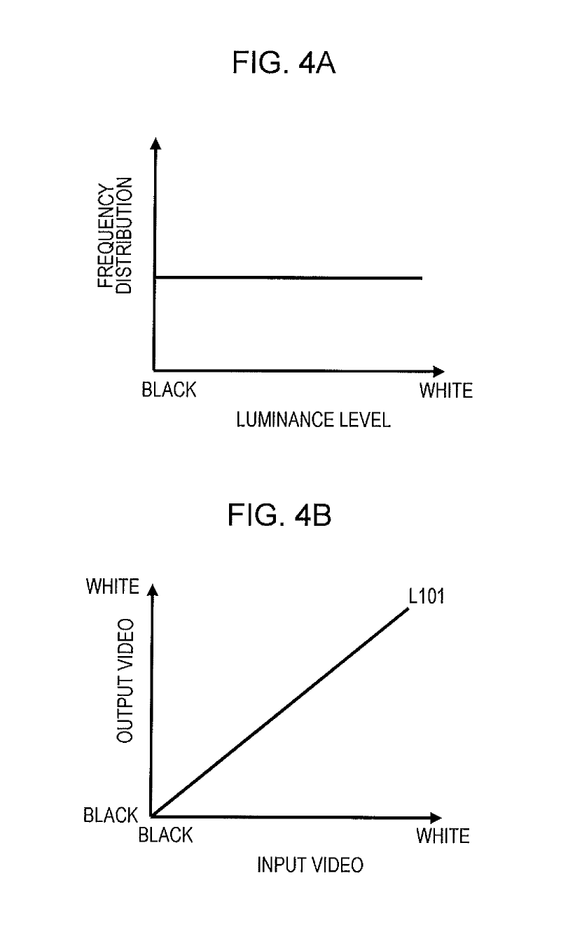

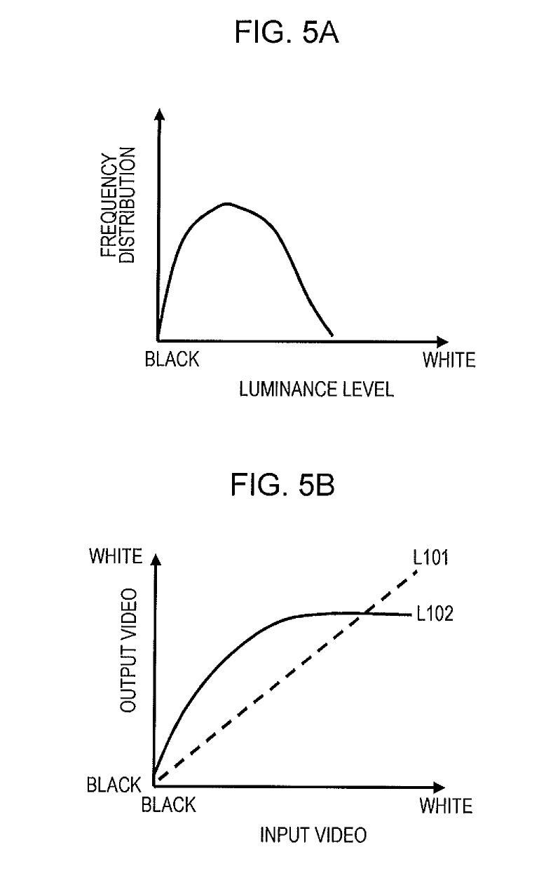

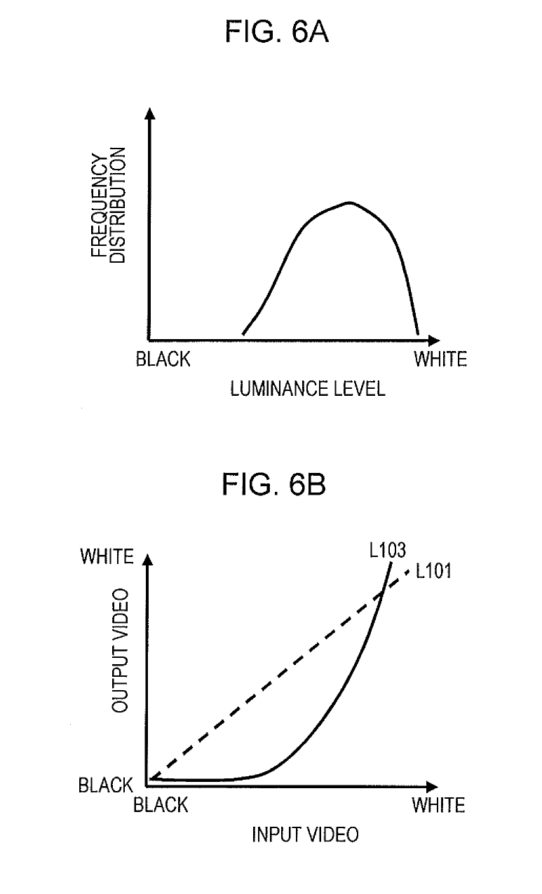

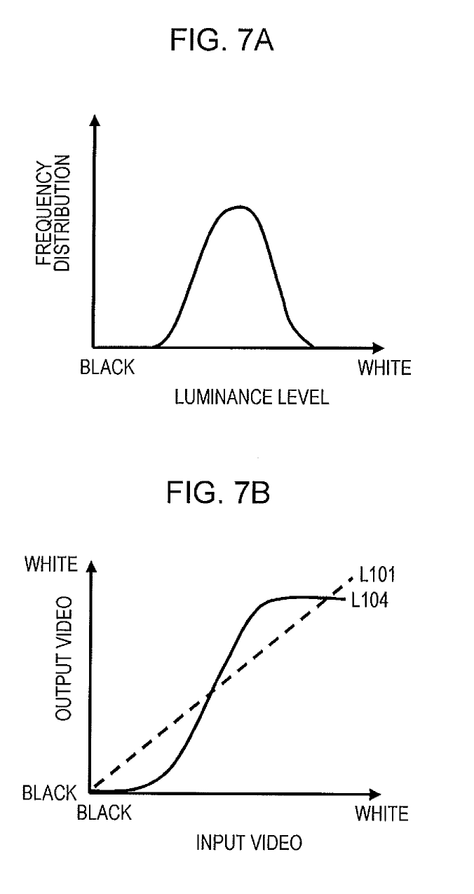

As depicted in FIG. 4A, when the luminance distribution of the input image is uniform, the gamma curve is represented by a straight line, as denoted by L101 in FIG. 4B, where an input and an output match. By contrast, as depicted in FIG. 5A, when the luminance distribution of the input image is in a low luminance region (a black level region), the gamma curve is represented by L102 in place of L101 as depicted in FIG. 5B. On the contrary, as depicted in FIG. 6A, when the luminance distribution of the input image is in a high luminance region (a white level region), the gamma curve is represented by L103 in place of L101 as depicted in FIG. 6B. Also, as depicted in FIG. 7A, when the luminance distribution of the input image is in an intermediate luminance region, the gamma curve is represented by L104 in place of L101 as depicted in FIG. 7B. The gamma curve can be obtained from an arithmetic operation of, for example, integrating the luminance distribution of the input image in a luminance level (horizontal axis) direction. With contrast correction, an improvement in contrast with luminance components of a high luminance frequency distribution prioritized is performed. Note that a degree of correction amount set for each luminance level when the gamma curve is corrected is referred to as a gain.

When image quality correction, such as contrast correction, is performed individually on two left-eye and right-eye video signals, the amount of process is enormous. Among others, calculation of a gamma curve takes a large amount of process.

Since a left-eye video and a right-eye video are shot normally by two cameras, a difference in performance between video signals may pose problems regarding the luminance and distortion of the lenses and a difference in light amount due to the positions of the cameras. However, regarding contrast, a difference in performance between the left-eye video and the right-eye video can be subtle. Therefore, the present inventors suggest a method of performing contrast correction by calculating a gamma curve based on the result of detecting a histogram of a luminance distribution from only one of the left-eye video and the right-eye video and applying the detection result to both of the left-eye video and the right-eye video. Calculation of a gamma curve for contrast correction on two left and right videos is performed only once, thereby reducing an amount of process. Only by cutting a histogram detection period by half, contrast correction on both of the left-eye video signal and the right-eye video signal can be made with the same process for a two-dimensional video signal.

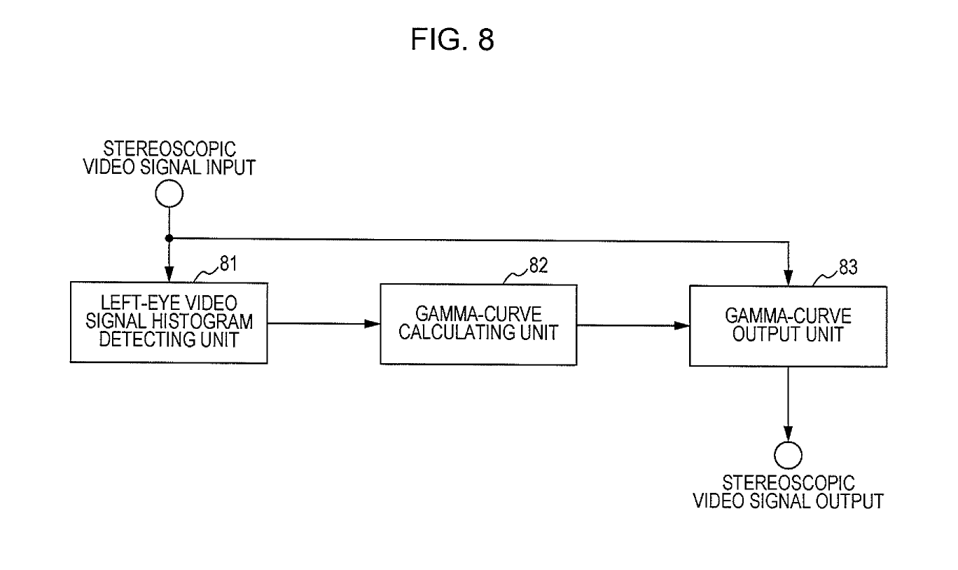

FIG. 8 depicts a functional structure for contrast correction on a stereoscopic video using only one of the left and right video signals, which is suggested by the present inventors. Functional blocks 81 to 83 depicted in FIG. 8 are implemented in, for example, the video signal processing unit 13.

A left-eye video signal histogram detecting unit 81 receives an input of a left-eye video signal among stereoscopic video signals to detect a histogram of a luminance distribution. However, in place of a left-eye video signal, a histogram of a luminance distribution for a right-eye video signal may be detected.

A gamma-curve calculating unit 82 calculates a gamma curve from the detection result of the histogram. An algorithm for calculating a gamma curve has been described above with reference to FIG. 4A to FIG. 7B. For example, a gamma curve can be obtained based on the result of integrating the histogram of the luminance distribution in a luminance level (horizontal axis) direction.

Upon receiving an input of the left-eye video signal and the right-eye video signal of the stereoscopic video, a gamma-curve output unit 83 converts the luminance level of each video signal according to the gamma curve calculated by the gamma-curve calculating unit 82 for output.

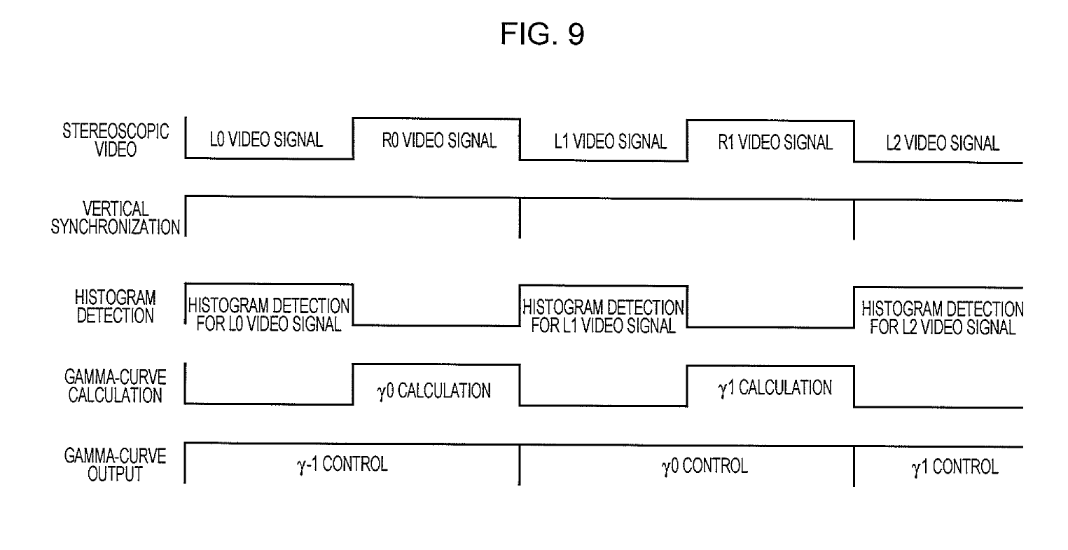

FIG. 9 is a timing chart when contrast correction is performed in the functional blocks depicted in FIG. 8. As depicted, over a period in which a left-eye video frame L0 is input, the left-eye video signal histogram detecting unit 81 detects a histogram of a luminance distribution. Subsequently, in a period in which a right-eye video frame R0 is input, the gamma-curve calculating unit 82 calculates a gamma curve γ0 to be used for the left and right video frames L0 and R0 from the histogram detection result. Then, using the obtained gamma curve γ0, the gamma-curve output unit 83 performs contrast correction on a left-eye video frame L1 and the right-eye video frame R0.

According to the contrast correction depicted in FIG. 8, calculation of a gamma curve for contrast correction on the two left and right videos is performed only once, thereby reducing the amount of process. Also, only by cutting a histogram detection period by half, contrast correction on both of the left-eye video signal and the right-eye video signal can be made with the same process for a two-dimensional video signal. Furthermore, since a difference in performance between a left-eye video and a right-eye video is subtle, a detrimental influence of cutting the histogram detection period by half is small.

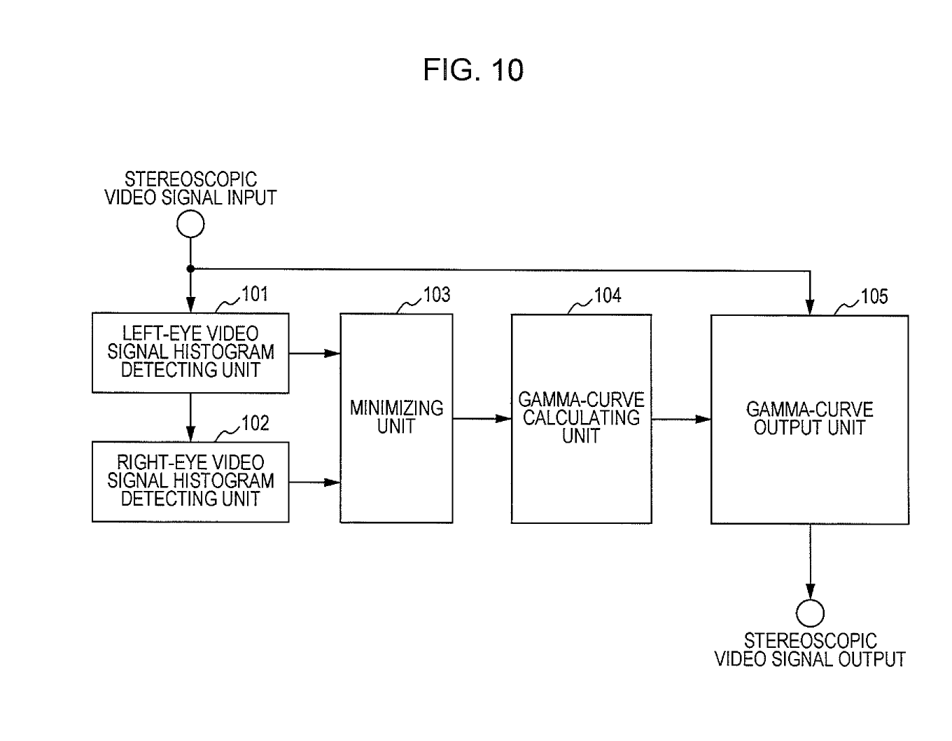

FIG. 10 depicts a functional structure for contrast correction of a stereoscopic video by performing histogram detection on both of the left and right video signals but performing calculation of a gamma curve only once. Functional blocks 101 to 105 depicted in FIG. 10 are implemented in, for example, the video signal processing unit 13.

A left-eye video signal histogram detecting unit 101 receives an input of a left-eye video signal among stereoscopic video signals to detect a histogram of a luminance distribution. Also, a right-eye video signal histogram detecting unit 102 receives an input of a right-eye video signal to detect a histogram of a luminance distribution.

Upon receiving each of the detected histograms of the luminance distributions from the left-eye video signal histogram detecting unit 101 and the right-eye video signal histogram detecting unit 102, a minimizing unit 103 minimizes the frequency distribution for each luminance level.

A gamma-curve calculating unit 104 calculates a gamma curve from the detection result of the minimized histogram. An algorithm for calculating a gamma curve has been described above with reference to FIG. 4A to FIG. 7B. For example, a gamma curve can be obtained based on the result of integrating the histogram of the luminance distribution in a luminance level (horizontal axis) direction.

Upon receiving an input of the left-eye video signal and the right-eye video signal of the stereoscopic video, a gamma-curve output unit 105 converts the luminance level of each video signal according to the gamma curve calculated by the gamma-curve calculating unit 104 for output.

The stereoscopic video has an occlusion region that can be only in one of the left-eye video signal and the right-eye video signal, that is, can be viewed only by one eye. The occlusion region may cause binocular retinal rivalry, but is not important in contrast correction. According to the contrast correction depicted in FIG. 10, by minimizing the histograms of the luminance distributions of the left and right video signals at the minimizing unit 103, a gamma curve can be calculated by ignoring the luminance distribution of the occlusion region and only using histogram information common to both of the left and right eyes.

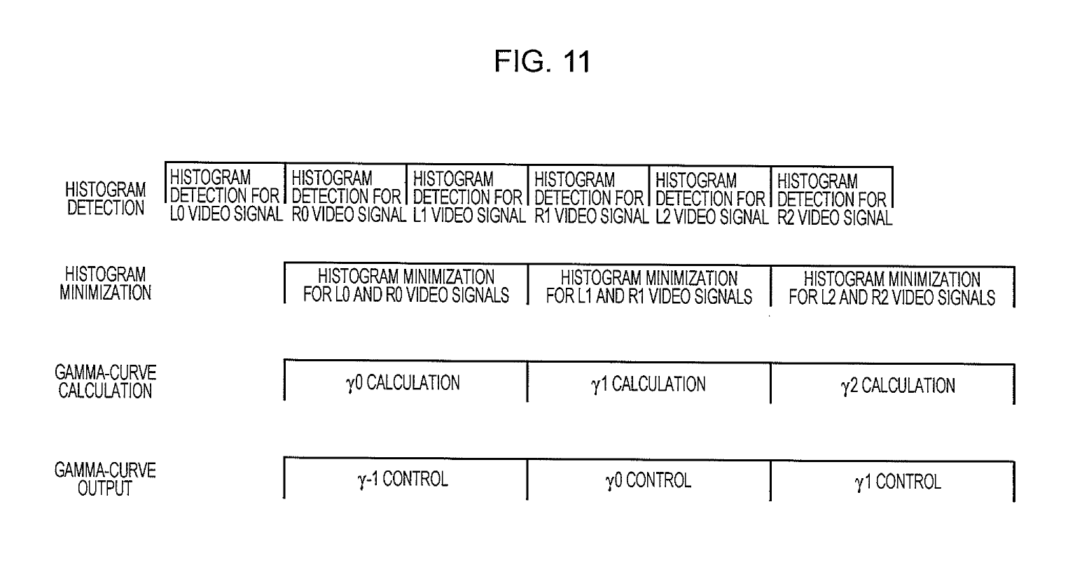

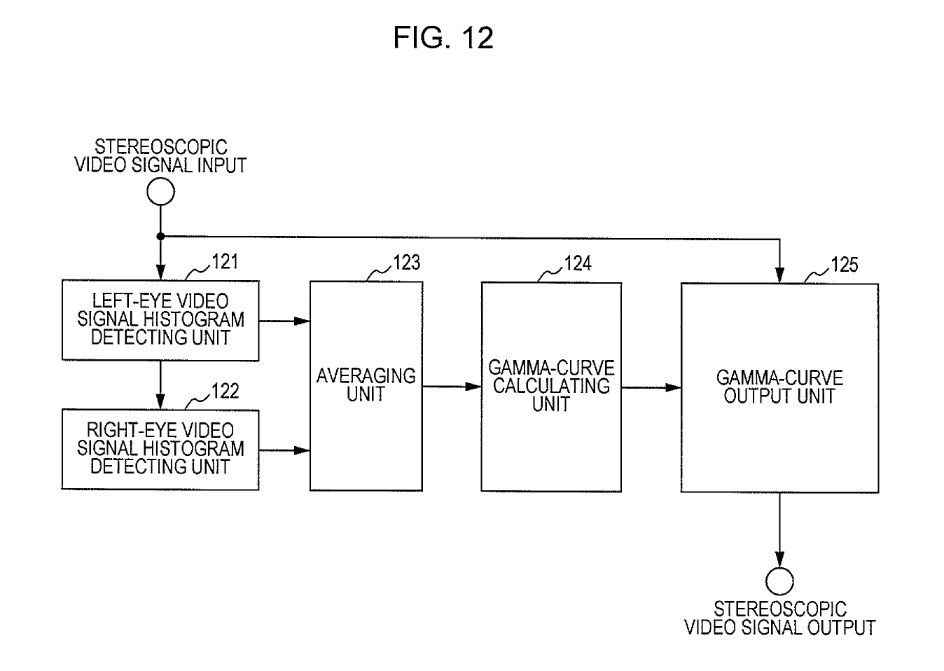

FIG. 11 is a timing chart when contrast correction is performed in the functional blocks depicted in FIG. 10. As depicted, over a period in which a left-eye video frame L0 is input, the left-eye video signal histogram detecting unit 101 detects a histogram of a luminance distribution. Subsequently, over a period in which a right-eye video frame R0 is input, the right-eye video signal histogram detecting unit 102 detects a histogram of a luminance distribution. In a period in which video frames R0 and L1 are input, the minimizing unit 103 minimizes each of the histograms of the luminance distributions of the left and right video signals for each luminance level. Also, the gamma-curve calculating unit 104 calculates a gamma curve γ0 to be used for the left and right video frames L0 and R0 from the result of detecting the minimized histogram. Then, using the obtained gamma curve γ0, the gamma-curve output unit 105 performs contrast correction on a right-eye video frame R1 and a left-eye video frame L2.

According to the contrast correction depicted in FIG. 10, calculation of a gamma curve for contrast correction on the two left and right videos is performed only once, thereby reducing the amount of process.

FIG. 12 depicts a functional structure for contrast correction of a stereoscopic video by performing histogram detection on both of the left and right video signals but performing calculation of a gamma curve only once. Functional blocks 121 to 125 depicted in FIG. 12 are implemented in, for example, the video signal processing unit 13.

A left-eye video signal histogram detecting unit 121 receives an input of a left-eye video signal among stereoscopic video signals to detect a histogram of a luminance distribution. Also, a right-eye video signal histogram detecting unit 122 receives an input of a right-eye video signal to detect a histogram of a luminance distribution.

Upon receiving each of the detected histograms of the luminance distributions from the left-eye video signal histogram detecting unit 121 and the right-eye video signal histogram detecting unit 122, an averaging unit 123 calculates a weighted average of the frequency distribution for each luminance level.

A gamma-curve calculating unit 124 calculates a gamma curve from the detection result of the minimized histogram. An algorithm for calculating a gamma curve has been described above with reference to FIG. 4A to FIG. 7B. For example, a gamma curve can be obtained based on the result of integrating the histogram of the luminance distribution in a luminance level (horizontal axis) direction.

Upon receiving an input of the left-eye video signal and the right-eye video signal of the stereoscopic video, a gamma-curve output unit 125 converts the luminance level of each video signal according to the gamma curve calculated by the gamma-curve calculating unit 124 for output.

Even when a difference in performance between the left-eye video signal and the right-eye video signal is large, the histograms of the luminance distributions detected from the left-eye video signal histogram detecting unit 121 and the right-eye video signal histogram detecting unit 122 are weighted-averaged, thereby reducing an influence of the difference in performance.

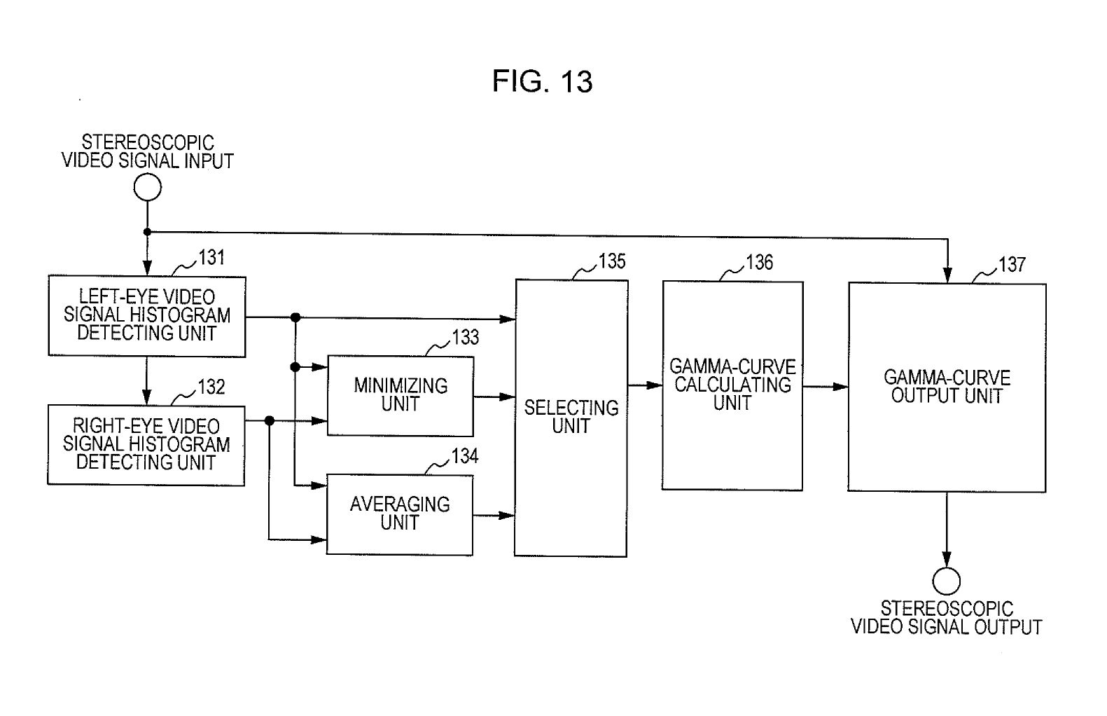

Three examples depicted in FIGS. 8, 10, and 12 have been described regarding contrast correction of a stereoscopic video, and have effects of a small amount of process, elimination of an influence of occlusion, and reduction in the difference in performance between the left and right video signals, respectively. Thus, these three processing methods may be combined as depicted in FIG. 13. Functional blocks 131 to 137 depicted in FIG. 13 are implemented in, for example, the video signal processing unit 13.

A left-eye video signal histogram detecting unit 131 receives an input of a left-eye video signal among stereoscopic video signals to detect a histogram of a luminance distribution. Also, a right-eye video signal histogram detecting unit 132 receives an input of a right-eye video signal to detect a histogram of a luminance distribution.

Upon receiving each of the detected histograms of the luminance distributions from the left-eye video signal histogram detecting unit 131 and the right-eye video signal histogram detecting unit 132, a minimizing unit 133 minimizes the frequency distribution for each luminance level.

Upon receiving each of the detected histograms of the luminance distributions from the left-eye video signal histogram detecting unit 131 and the right-eye video signal histogram detecting unit 132, an averaging unit 134 calculates a weighted average of the frequency distribution for each luminance level.

A selecting unit 135 selects a histogram to be input to a gamma-curve calculating unit 136 from among outputs from the left-eye video signal histogram detecting unit 131, the minimizing unit 133, and the averaging unit 134. For example, the selecting unit 135 selects the output from the left-eye video signal histogram detecting unit 131 when the histogram detection period is desired to be shortened, selects the output from the minimizing unit 133 when an influence of the occlusion region is desired to be eliminated, and selects the output from the averaging unit 134 when a difference in performance between the left and right video signals is reduced.

The selecting unit 135 determines any one of the outputs from the left-eye video signal histogram detecting unit 131, the minimizing unit 133, and the averaging unit 134 according to, for example, an operation switch included in the stereoscopic video display system 1 or a remote control signal received from a remote controller (not shown). Alternatively, selection switching at the selecting unit 135 may be made through maintenance by a service engineer.

The gamma-curve calculating unit 136 calculates a gamma curve using the histogram selected by the selecting unit 135. An algorithm for calculating a gamma curve has been described above with reference to FIG. 4A to FIG. 7B. For example, a gamma curve can be obtained based on the result of integrating the histogram of the luminance distribution in a luminance level (horizontal axis) direction.

Upon receiving an input of the left-eye video signal and the right-eye video signal of the stereoscopic video, a gamma-curve output unit 137 converts the luminance level of each video signal according to the gamma curve calculated by the gamma-curve calculating unit 136 for output.

It should be understood by those skilled in the art that various modifications, combinations, sub-combinations and alterations may occur depending on design requirements and other factors insofar as they are within the scope of the appended claims or the equivalents thereof.

What is claimed is:

1. A video signal processing apparatus comprising:
a histogram detecting unit detecting a histogram of a luminance distribution of either one of a left-eye video signal and a right-eye video signal among input stereoscopic video signals;
a gamma-curve calculating unit calculating a gamma curve based on the histogram detected by the histogram detecting unit; and
a gamma-curve output unit correcting the left-eye video signal and the right-eye video signal based on the gamma curve calculated by the gamma-curve calculating unit.

2. A video signal processing apparatus comprising:
a left-eye video signal histogram detecting unit detecting a histogram of a luminance distribution of a left-eye video signal among input stereoscopic video signals;
a right-eye video signal histogram detecting unit detecting a histogram of a luminance distribution of a right-eye video signal among the stereoscopic video signals;
a minimizing unit minimizing the histograms detected by the left-eye video signal histogram detecting unit and the right-eye video signal histogram detecting unit for each luminance level;
a gamma-curve calculating unit calculating a gamma curve based on the histograms processed by the minimizing unit; and
a gamma-curve output unit correcting the left-eye video signal and the right-eye video signal based on the gamma curve calculated by the gamma-curve calculating unit.

3. A video signal processing apparatus comprising:
a left-eye video signal histogram detecting unit detecting a histogram of a luminance distribution of a left-eye video signal among input stereoscopic video signals;
a right-eye video signal histogram detecting unit detecting a histogram of a luminance distribution of a right-eye video signal among the stereoscopic video signals;
an averaging unit weighted-averaging the histograms detected by the left-eye video signal histogram detecting unit and the right-eye video signal histogram detecting unit;
a gamma-curve calculating unit calculating a gamma curve based on the histograms weighted-averaged by the averaging unit; and
a gamma-curve output unit correcting the left-eye video signal and the right-eye video signal based on the gamma curve calculated by the gamma-curve calculating unit.

4. A video signal processing apparatus comprising:
a left-eye video signal histogram detecting unit detecting a histogram of a luminance distribution of a left-eye video signal among input stereoscopic video signals;
a right-eye video signal histogram detecting unit detecting a histogram of a luminance distribution of a right-eye video signal among the stereoscopic video signals;
a minimizing unit minimizing the histograms detected by the left-eye video signal histogram detecting unit and the right-eye video signal histogram detecting unit for each luminance level;
an averaging unit weighted-averaging the histograms detected by the left-eye video signal histogram detecting unit and the right-eye video signal histogram detecting unit;
a selecting unit selecting any one of the histograms output from the left-eye video signal histogram detecting unit, the minimizing unit, and the averaging unit;
a gamma-curve calculating unit calculating a gamma curve based on the histogram selected by the selecting unit; and
a gamma-curve output unit correcting the left-eye video signal and the right-eye video signal based on the gamma curve calculated by the gamma-curve calculating unit.

5. A video signal processing method comprising:
a histogram detecting step of detecting a histogram of a luminance distribution of either one of a left-eye video signal and a right-eye video signal among input stereoscopic video signals;
a gamma-curve calculating step of calculating a gamma curve based on the histogram detected in the histogram detecting step; and
a gamma-curve outputting step of correcting the left-eye video signal and the right-eye video signal based on the gamma curve calculated in the gamma-curve calculating step.

6. A video signal processing method comprising:
a left-eye video signal histogram detecting step of detecting a histogram of a luminance distribution of a left-eye video signal among input stereoscopic video signals;
a right-eye video signal histogram detecting step of detecting a histogram of a luminance distribution of a right-eye video signal among the stereoscopic video signals;
a minimizing step of minimizing the histograms detected in the left-eye video signal histogram detecting step and the right-eye video signal histogram detecting step for each luminance level;
a gamma-curve calculating step of calculating a gamma curve based on the histograms processed in the minimizing step; and
a gamma-curve outputting step of correcting the left-eye video signal and the right-eye video signal based on the gamma curve calculated in the gamma-curve calculating step.

7. A video signal processing method comprising:
a left-eye video signal histogram detecting step of detecting a histogram of a luminance distribution of a left-eye video signal among input stereoscopic video signals;
a right-eye video signal histogram detecting step of detecting a histogram of a luminance distribution of a right-eye video signal among the stereoscopic video signals;
an averaging step of weighted-averaging the histograms detected in the left-eye video signal histogram detecting step and the right-eye video signal histogram detecting step;
a gamma-curve calculating step of calculating a gamma curve based on the histograms weighted-averaged in the averaging step; and
a gamma-curve outputting step of correcting the left-eye video signal and the right-eye video signal based on the gamma curve calculated in the gamma-curve calculating step.

8. A video signal processing method comprising:
a left-eye video signal histogram detecting step of detecting a histogram of a luminance distribution of a left-eye video signal among input stereoscopic video signals;
a right-eye video signal histogram detecting step of detecting a histogram of a luminance distribution of a right-eye video signal among the stereoscopic video signals;
a minimizing step of minimizing the histograms detected in the left-eye video signal histogram detecting step and the right-eye video signal histogram detecting step for each luminance level;
an averaging step of weighted-averaging the histograms detected in the left-eye video signal histogram detecting step and the right-eye video signal histogram detecting step;
a selecting step of selecting any one of the histograms output in the left-eye video signal histogram detecting step, the minimizing step, and the averaging step;
a gamma-curve calculating step of calculating a gamma curve based on the histogram selected in the selecting step; and
a gamma-curve outputting step of correcting the left-eye video signal and the right-eye video signal based on the gamma curve calculated in the gamma-curve calculating step.

9. A computer program described in a computer-readable format so that stereoscopic video signals are processed on a computer, the computer program causing the computer to function as units comprising:
a histogram detecting unit detecting a histogram of a luminance distribution of either one of a left-eye video signal and a right-eye video signal among the stereoscopic video signals;
a gamma-curve calculating unit calculating a gamma curve based on the histogram detected by the histogram detecting unit; and
a gamma-curve output unit correcting the left-eye video signal and the right-eye video signal based on the gamma curve calculated by the gamma-curve calculating unit.

10. A computer program described in a computer-readable format so that stereoscopic video signals are processed on a computer, the computer program causing the computer to function as units comprising:
a left-eye video signal histogram detecting unit detecting a histogram of a luminance distribution of a left-eye video signal among the stereoscopic video signals;
a right-eye video signal histogram detecting unit detecting a histogram of a luminance distribution of a right-eye video signal among the stereoscopic video signals;
a minimizing unit minimizing the histograms detected by the left-eye video signal histogram detecting unit and the right-eye video signal histogram detecting unit for each luminance level;
a gamma-curve calculating unit calculating a gamma curve based on the histograms processed by the minimizing unit; and
a gamma-curve output unit correcting the left-eye video signal and the right-eye video signal based on the gamma curve calculated by the gamma-curve calculating unit.

11. A computer program described in a computer-readable format so that stereoscopic video signals are processed on a computer, the computer program causing the computer to function as units comprising:
a left-eye video signal histogram detecting unit detecting a histogram of a luminance distribution of a left-eye video signal among the stereoscopic video signals;
a right-eye video signal histogram detecting unit detecting a histogram of a luminance distribution of a right-eye video signal among the stereoscopic video signals;
an averaging unit weighted-averaging the histograms detected by the left-eye video signal histogram detecting unit and the right-eye video signal histogram detecting unit;
a gamma-curve calculating unit calculating a gamma curve based on the histograms weighted-averaged by the averaging unit; and
a gamma-curve output unit correcting the left-eye video signal and the right-eye video signal based on the gamma curve calculated by the gamma-curve calculating unit.

12. A computer program described in a computer-readable format so that stereoscopic video signals are processed on a computer, the computer program causing the computer to function as units comprising:
a left-eye video signal histogram detecting unit detecting a histogram of a luminance distribution of a left-eye video signal among the stereoscopic video signals;
a right-eye video signal histogram detecting unit detecting a histogram of a luminance distribution of a right-eye video signal among the stereoscopic video signals;
a minimizing unit minimizing the histograms detected by the left-eye video signal histogram detecting unit and the right-eye video signal histogram detecting unit for each luminance level;
an averaging unit weighted-averaging the histograms detected by the left-eye video signal histogram detecting unit and the right-eye video signal histogram detecting unit;
a selecting unit selecting any one of the histograms output from the left-eye video signal histogram detecting unit, the minimizing unit, and the averaging unit;
a gamma-curve calculating unit calculating a gamma curve based on the histogram selected by the selecting unit; and
a gamma-curve output unit correcting the left-eye video signal and the right-eye video signal based on the gamma curve calculated by the gamma-curve calculating unit.
